(19) United States
(12) Patent Application Publication
(10) Pub. No.: US 2019/0208745 A1
(43) Pub. Date: Jul. 11, 2019

(54) PET WATERING FOUNTAIN

(71) Applicant: Radio Systems Corporation, Knoxville, TN (US)

(72) Inventors: Darren Milsom, Knoxville, TN (US); Marc E. Brush, Knoxville, TN (US)

(21) Appl. No.: 16/354,733

(22) Filed: Mar. 15, 2019

Related U.S. Application Data
(63) Continuation-in-part of application No. 15/987,251, filed on May 23, 2018.
(60) Provisional application No. 62/509,791, filed on May 23, 2017.

(51) Int. Cl. A01K 7/02

(52) U.S. Cl. CPC A01K 7/022; F04B 19/006

(57) ABSTRACT

A pet watering fountain includes a bowl having a wall extending to a floor. The floor includes a lower area defining a sump with a sump floor. The sump floor has a height lower than the height of the surrounding portion of the floor. The housing divides the basin into a drinking basin and an interior basin. The drinking basin is accessible to an animal while the interior basin is located behind and underneath the housing and is not accessible to the animal. The pump has an inlet plate with inlet openings located near the bottom of the pump below the level of the bowl floor surrounding portion so that the bowl floor surrounding portion may be devoid of water yet the pump may still have enough water to keep it pumping and prevent it from overheating due to the water within the sump above the inlet openings.

### CROSS REFERENCE TO RELATED APPLICATIONS

This application is a continuation in part application of U.S. application Ser. No. 15/987,251, filed May 23, 2018, which claims the benefit of U.S. application No. 62/509,791, filed May 23, 2017.

### STATEMENT REGARDING FEDERALLY SPONSORED RESEARCH OR DEVELOPMENT

Not applicable.

### THE NAMES OF THE PARTIES TO A JOINT RESEARCH AGREEMENT

Not applicable.

### TECHNICAL FIELD

The present disclosure relates to the field of pet watering fountains. More particularly, the disclosure relates to a pet watering fountain which is designed to prevent overheating and noise reduction of the water pump of the pet water fountain.

### BACKGROUND OF THE INVENTION

Many animals have a preference for drinking flowing water. Flowing water is desirable for animals as it increases interest, encouraging them to drink more fluids. This, in turn, can help reduce problems with the animal's kidneys or urinary tract. Flowing water also improves water taste and quality, as flowing water typically has more dissolved oxygen, which can make the water taste better as well as provide potential health benefits.

To provide flowing water for an animal, water fountains have been devised. These water fountains utilize a water pump to circulate the water. However, when the water level within the water fountain reaches a minimal level, the pump may cause air to be introduced into the water pump, causing a dramatic increase in the noise produced by the water fountain. If the water reaches a level below the intake of the water pump, the pump may overheat.

Accordingly, a need exists for an easily-maintained animal watering fountain that provides substantially continuously-moving, filtered, drinking water for animals without creating a significant amount of noise or overheating the water pump.

This section is intended to introduce various aspects of the art, which may be associated with exemplary embodiments of the present disclosure. This discussion is believed to assist in providing a framework to facilitate a better understanding of particular aspects of the present disclosure. Accordingly, it should be understood that this section should be read in this light, and not necessarily as admissions of prior art.

### BRIEF SUMMARY OF THE INVENTION

An animal watering fountain is provided herein. In one embodiment, the animal watering fountain for dispensing an aqueous drinking fluid comprises a bowl defining a wall for holding an aqueous drinking fluid. The bowl is divided into a drinking basin which is accessible to a domesticated pet, and an interior basin which is not accessible to the pet. The drinking basin has a drinking basin floor positioned at a first selected height. The interior basin has a sump portion with a sump floor positioned at a second selected height less than the first selected height of the drinking basin floor The animal watering fountain also has a housing configured to cover the interior basin. The housing has an inlet port to receive water from the drinking basin. The animal watering fountain also has a pump mounted within the sump portion and configured to receive the drinking fluid from the sump portion.

### BRIEF DESCRIPTION OF THE DRAWINGS

So that the manner in which the present inventions can be better understood, certain illustrations, charts and/or flow charts are appended hereto. It is to be noted, however, that the drawings illustrate only selected embodiments of the inventions and are therefore not to be considered limiting of scope, for the inventions may admit to other equally effective embodiments and applications.

FIG. 1 is a perspective, cross-sectional view of an animal watering fountain of the present invention, in one embodiment.

FIG. 2 is a perspective, cross-sectional view of the animal watering fountain of FIG. 1.

FIG. 3 is a perspective view of an alternative embodiment of the water pump of the animal watering fountain of FIG. 1.

### DETAILED DESCRIPTION OF CERTAIN EMBODIMENTS

### Definitions

For purposes of the present disclosure, it is noted that spatially relative terms, such as “up,” “down,” “right,” “left,” “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over or rotated, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

### Description of Selected Specific Embodiments

With reference next to the drawings, there is shown an animal watering device or pet watering fountain 100 of the present invention, in one embodiment. The animal watering fountain 100 includes a bowl 110. The bowl 110 defines a radial exterior wall 112 extending to an interior wall 113 which in turn extends to a generally horizontal floor 114. The floor 114 includes a lower area or sump 116 with a sump floor 117. The sump floor 117 has a height which is lower than the height of the sump surrounding portion floor 118 of the floor 114. The floor 114 and walls 112 and 113 are configured to together hold an aqueous drinking fluid 310 for a pet. The sump 116 also has a top edge 119 which is positioned at or below the level of the surrounding portion floor 118.

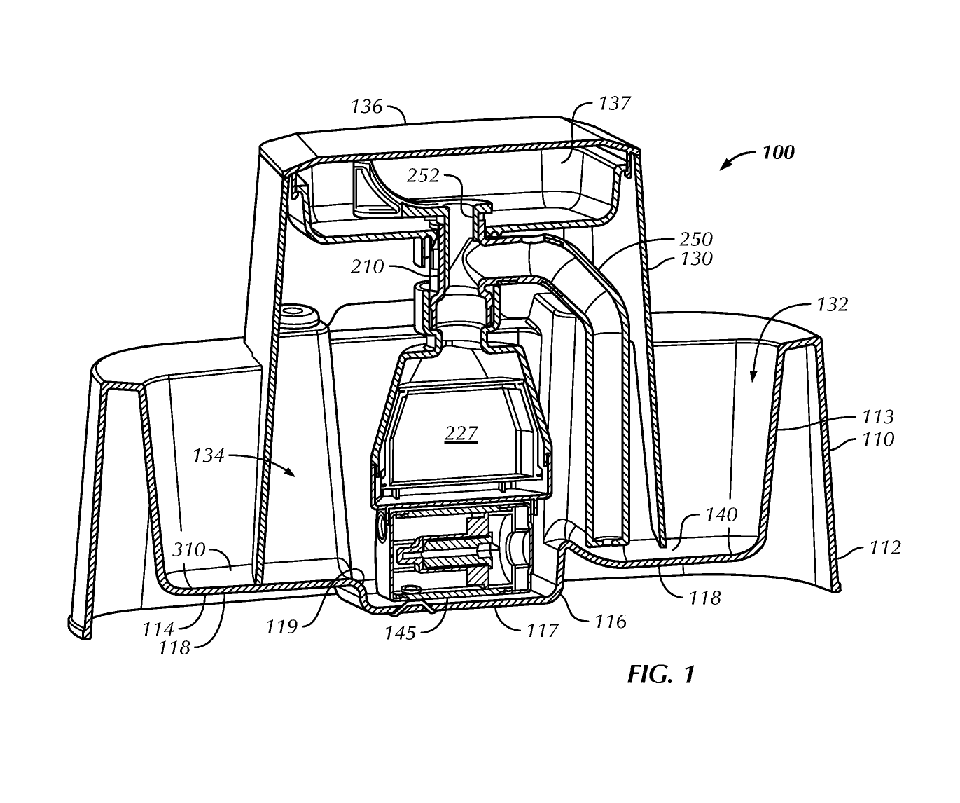

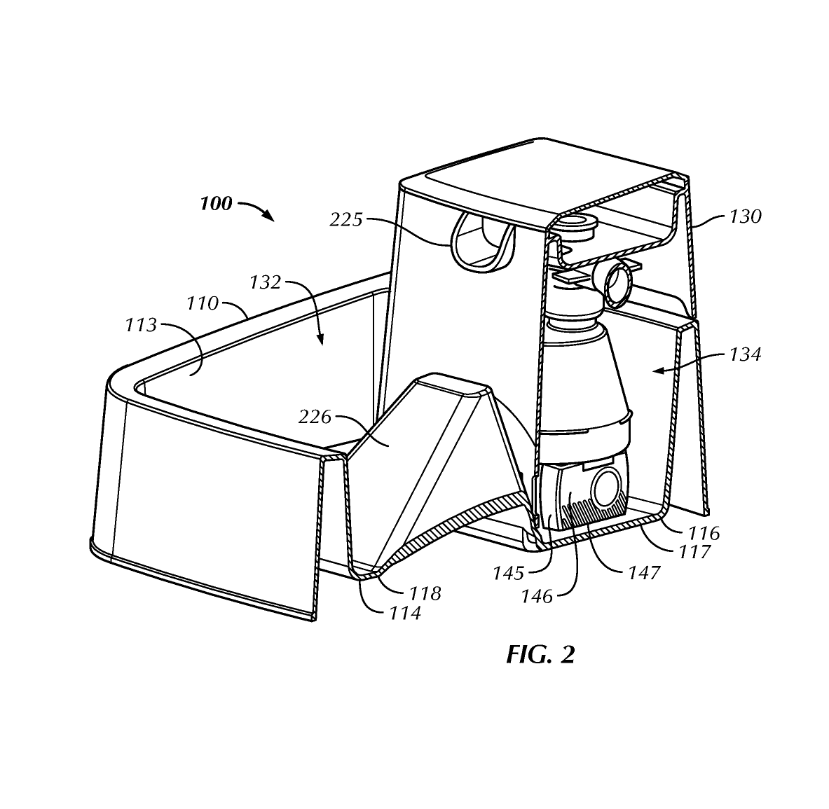

The animal watering fountain 100 not only holds an aqueous fluid (such as water), but also circulates that water 310 so that it remains fresh and oxygenated. In addition, the water 310 may be filtered so that it is maintained in a clean or particle-free state. In order to provide the circulation and filtering functions, various components are provided. Those components are generally held within a housing 130. Components of the housing 130 are visible in the cross-sectional view of FIGS. 1 and 2.

The housing 130 divides the bowl into a drinking portion or basin 132 and an interior portion or basin 134. The drinking basin 132 is accessible to an animal at the front of the fountain 100, while the interior basin 134 is located behind and underneath the housing 130 and is not accessible to the animal. The drinking basin 132 is defined by the bowl 110, the surrounding portion floor 118 of the floor 114, and the housing 130, and exists beyond the confines of or not covered by the housing 130. A cap 136 is removably mounted to the housing 130 to expose a reservoir 137.

The watering fountain housing 130 has an inlet or inlet port 140 therethrough to provide fluid communication between the drinking basin 132 and the interior basin 134. Water is circulated from the drinking basin 132, through the inlet port 140, and to a submersible liquid pump 145 within the sump 116. The pump 145 has an inlet plate 146 with inlet openings 147 therethrough which allow water to enter the pump 145. The inlet openings 147 are located near the bottom of the pump and preferably extend entirely within the bottom one third of the height of the inlet plate 146. The entire inlet openings 147 are positioned below the level of the bowl floor surrounding portion floor 118 and at or below the level of the sump top edge 119, so that the bowl floor surrounding portion floor 118 may be devoid of water yet the pump may still have enough water to keep it pumping and preventing it from overheating due to the water within the sump being above the inlet openings 147. During circulation, the water 310 circulates between the drinking basin 132 and the interior basin 134.

Water is drawn into the interior basin 134 through the inlet port 140 and into the sump 116. The water is then pumped through pump 145, through a lift pipe 210, and into the reservoir 137, where it is then released through a spout opening 225. Water falls from the spout opening 225 and into the drinking basin 132. The lift pipe 210 is coupled and in fluid communication with a return pipe 250, the flow through each being controlled through a flow control tube or valve 252.

An unshown filter may resides within the sump 116 about the pump 145. A second unshown filter, such as a charcoal type filter, may be positioned within a filter chamber 227 between the pump 145 and the lift pipe 210.

Concerning the housing 130, the housing 130 may be a removable component that snaps in and out of place. The housing 130 may be made of a plastic, glass, metal, ceramic or other material.

Optionally, a splash ramp 226 is provided above the water level in the drinking basin 132. This keeps water from splattering over the wall 112 and out of the bowl 110. It is observed in FIG. 2 that the splash ramp 226 forms a sloped surface that is angled towards the radial wall 112. Optionally, the splash ramp 226 is an island around which water 310 circulates within the bowl 110.

In operation, the owner fills the drinking basin 132 with water, and then activates the submersible pump 145. Enough water 310 is placed within the bowl 110 so that it occupies the vast majority of the drinking basin 132 and the interior basin 134. The pump 145 is turned on and water from the sump 116 is drawn into the pump 145 where it is filtered by a foam pre-filter. As water 310 exits the pump 145, it travels through the filter chamber 227 and through the lift pipe 210 to the reservoir 137, when the valve 252 is in a closed position. Water then falls through the spout opening 225 and back into the drinking basin. The water 310 may be diverted from the lift pipe 210 to the return pipe 250 and back to the interior basin 134 when the valve 252 is in an open position.

As water is removed from the animal watering fountain 100 through the drinking of the animal or evaporation, or a combination thereof, the water 310 within the bowl 110 slowly recedes or lowers. Should enough water 310 be removed from the bowl 110, the remaining water within the drinking portion 132 will reach the level of the surrounding portion floor 118 of floor 114. However, as the sump 116 is positioned below the level of the drinking portion floor 114 (surrounding portion floor 118), the water 310 remains within the sump 116.

The pump 145 has the inlet openings 147 of the inlet plate 146 located at the bottommost portion of the inlet plate 146. Thus, the water 310 will continue to be pulled into the pump 145 even though the drinking basin 132 has become low, even to the point of the drinking basin 132 has become completely dry. This continued flow of water into the pump restricts the noise generated by a dry pump or a pump taking in air with the water, and restricts the overheating of the dry pump. This also allows a person additional time to add water to the animal watering fountain 100 before harming the pump 145 due to the lack of water.

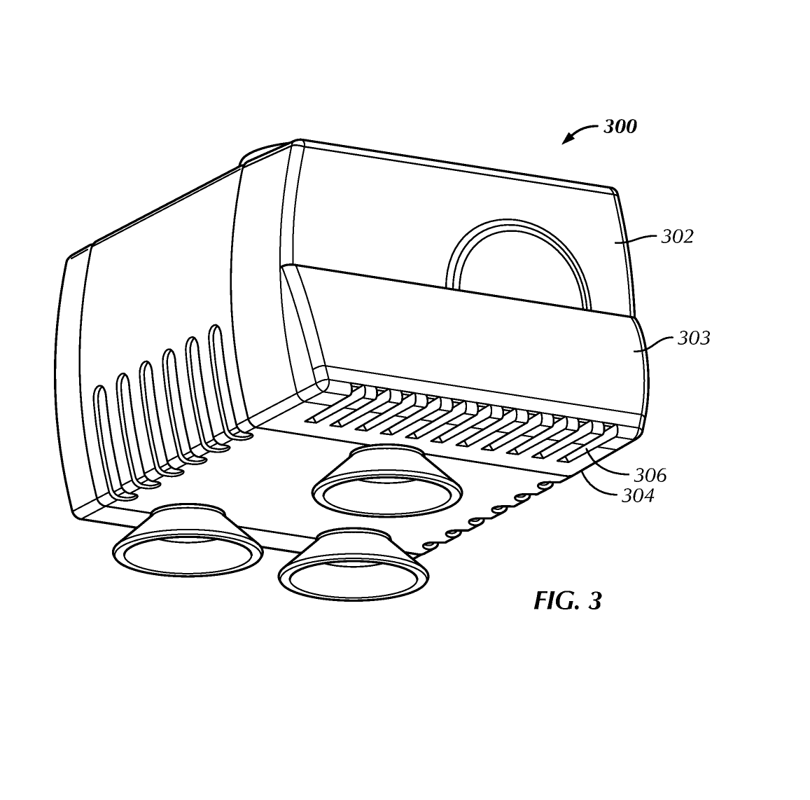

The watering fountain presented in the figures discussed above is just one embodiment of the invention claimed herein. Other embodiments may be employed without departing from the broader scope and spirit of the present general inventive concept. For example, FIG. 3 shows a pump 300 in an alternative embodiment. Here, the pump 300 includes an inlet plate 302 which has a side surface or wall 303 and bottom surface or wall 304 facing the sump floor 117. The bottom surface 304 includes inlet openings 306. Thus, the inlet openings 306 are in the bottommost part of the inlet plate 302 to maximize water being able to be pulled into the pump 145 without the introduction of air which would defeat this from occurring. Through the pulling or siphoning of the water through the bottom inlet openings 306, water within the sump maintains the flow of water through the pump 145.

It should be understood that the bowl floor surrounding portion floor 118 and sump 116 may be formed by a plate or liner removably mounted with the bowl 110.

An animal watering fountain 100 for dispensing an aqueous drinking fluid 310 of an embodiment comprises a bowl 110 defining a wall 112 for holding an aqueous drinking fluid. The bowl 110 is divided into a drinking basin 132 which is accessible to a domesticated pet, and an interior basin 134 which is not accessible to the pet. The drinking basin 132 has a drinking basin floor 114 positioned at a first selected height. The interior basin has a sump portion 116 with a sump floor 117 positioned at a second selected height less than the first selected height of the drinking basin floor The animal watering fountain 100 also has a housing 130 configured to cover the interior basin 134. The housing 130 has an inlet 140 to receive water from the drinking basin 132. The animal watering fountain 100 also has a pump 145 mounted within the sump portion 116 and configured to receive the drinking fluid from the sump portion 116.

The animal watering fountain 100 also comprises the pump 145 including an inlet plate 146 having at least one inlet opening 147 positioned closely adjacent a bottom of the inlet plate.

The animal watering fountain 100 also comprises the inlet opening 147 being located entirely within a bottom one third of the height of the inlet plate 146.

The animal watering fountain 100 also comprises the inlet opening 147 being positioned entirely lower than the first selected height of the drinking basin floor 117.

The animal watering fountain 100 also comprises the inlet plate 146 having a vertical side surface and a bottom surface, wherein the inlet opening 147 extends from the bottom surface.

The animal watering fountain 100 also comprises the sump portion 116 has a top edge 119 positioned at a height less than or equal to the first selected height of the drinking basin surrounding floor 118.

An animal watering fountain 100 for dispensing an aqueous drinking fluid 310 of an embodiment comprises a wall 113 and a floor 114 defining a bowl 110, a housing 130 coupled to the bowl 110, the housing 130 defining an interior basin 134 positioned beneath the housing 130 and a drinking basin 132 exterior of the housing defined by the floor 114 and the area between the housing 130 and the wall 113, the housing 130 having an inlet 140 for fluid communication between the drinking basin 132 and the interior basin 134, a sump 116 extending downwardly from the floor 114, the sump 116 being positioned within the interior basin 134, and a pump 145 mounted within the sump 116 and configured to receive the drinking fluid 310 from the sump 116.

An animal watering fountain 100 for dispensing an aqueous drinking fluid 310 of an embodiment comprises a bowl 110 having a sump 116 with a sump floor 117, the bowl also has a surrounding floor 118 positioned about the sump floor 117 at a height greater than the sump floor 117, a pump 145 mounted within the sump 116 and configured to receive the drinking fluid 310 from the sump 116, and a housing 130 coupled to the bowl 110. The housing 130 covering the sump 116 and pump 145 prevents animal access to the pump 145 and other components. The bowl 110, housing 130, and surrounding floor 117 defining a drinking basin 132 outside the confines of the housing 130.

Variations of the animal watering fountain may fall within the spirit of the claims, below. It will be appreciated that the inventions are susceptible to modification, variation, and change without departing from the spirit thereof.

1. An animal watering fountain for dispensing an aqueous drinking fluid, comprising:
a bowl defining a wall for holding an aqueous drinking fluid, the bowl being divided into a drinking basin which is accessible to a domesticated pet, and an interior basin which is not accessible to the pet, the drinking basin having a drinking basin floor positioned at a first selected height, the interior basin having a sump portion with a sump floor positioned at a second selected height less than the first selected height of the drinking basin floor;
a housing configured to cover the interior basin, the housing having an inlet port to receive water from the drinking basin;
a pump mounted within the sump portion and configured to receive the drinking fluid from the sump portion.

2. The animal watering fountain of claim 1, wherein the pump includes an inlet plate having at least one inlet opening positioned closely adjacent a bottom of the inlet plate.

3. The animal watering fountain of claim 2, wherein the inlet opening is located entirely within a bottom one third of the height of the inlet plate.

4. The animal watering fountain of claim 2, wherein the inlet opening is positioned entirely lower than the first selected height of the drinking basin floor.

5. The animal watering fountain of claim 2, wherein the inlet plate has a vertical side surface and a bottom surface, and wherein the inlet opening extends from the bottom surface.

6. The animal watering fountain of claim 1, wherein the sump portion has a top edge positioned at a height less than or equal to the first selected height of the drinking basin floor.

7. An animal watering fountain for dispensing an aqueous drinking fluid, comprising:
a wall and a floor defining a bowl;
a housing coupled to the bowl, the housing defining an interior basin positioned beneath the housing and a drinking basin defined by the floor, and the area between the housing and the wall, the housing having an inlet port for fluid communication between the drinking basin and the interior basin;
a sump extending downwardly from the floor, the sump being positioned within the interior basin, and
a pump mounted within the sump and configured to receive the drinking fluid from the sump.

8. The animal watering fountain of claim 7, wherein the pump includes an inlet plate having at least one inlet opening positioned closely adjacent a bottom of the inlet plate.

9. The animal watering fountain of claim 8, wherein the inlet opening is located entirely within a bottom one third of the height of the inlet plate.

10. The animal watering fountain of claim 8, wherein the inlet opening is positioned entirely lower than the drinking basin floor.

11. The animal watering fountain of claim 8, wherein the inlet plate has a vertical side surface and a bottom surface, and wherein the inlet opening extends from the bottom surface.

12. The animal watering fountain of claim 7, wherein the sump has a top edge positioned at or below the floor.

13. An animal watering fountain for dispensing an aqueous drinking fluid, comprising:
a bowl having a sump with a sump floor, a surrounding floor positioned about the sump floor at a height greater than the sump floor;
a pump mounted within the sump and configured to receive the drinking fluid from the sump;
a housing coupled to the bowl, the housing covering the sump and pump to prevent animal access to the sump, and
the bowl, housing, and surrounding floor defining a drinking basin outside the confines of the housing.

14. The animal watering fountain of claim 13, wherein the pump includes an inlet plate having at least one inlet opening positioned closely adjacent a bottom of the inlet plate.

15. The animal watering fountain of claim 14, wherein the inlet opening is located entirely within a bottom one third of the height of the inlet plate.

16. The animal watering fountain of claim 14, wherein the inlet opening is positioned entirely lower than the surrounding floor.

17. The animal watering fountain of claim 14, wherein the inlet plate has a vertical side surface and a bottom surface, and wherein the inlet opening extends from the bottom surface.

18. The animal watering fountain of claim 13, wherein the sump has a top edge positioned at or below the surrounding floor.
